(19) United States
(12) Patent Application Publication
(10) Pub. No.: US 2008/0154552 A1
(43) Pub. Date: Jun. 26, 2008

(54) Computer aided design of rock drilling bit

(75) Inventors: Chih C. Lin, Spring, TX (US); Yansong Wang, Conroe, TX (US)

Correspondence Address: TRAVIS HIGGINS, 10919 COVERED BRIDGE, HOUSTON, TX, 77075, US

(73) Assignee: Baker Hughes Incorporated

(21) Appl. No.: 11/642,755

(22) Filed: Dec. 20, 2006

(51) Int. Cl. G06F 17/50

(52) U.S. Cl. 703/1

(57) ABSTRACT

A steady-state mixed thermo-elasto-hydrodynamic computer model is used to design earth boring drill bits, and in particular, to optimize the design of the journal and thrust bearings within the earth boring drill bit. The model incorporates the texture of the bearing surfaces, asperity contact, surface thermoelastic deformation, the temperature-pressure-viscosity relationship of the lubricant, and the angular misalignment between the journal and the bearing.

### BACKGROUND OF THE INVENTION

1. Field of the Invention

This invention relates in general to earth-boring rotary cone drill bits and in particular to the design of such bits and optimization of the bearings by numerical modeling and simulation.

2. Description of the Related Art

In drilling boreholes in earthen formations by the rotary method, earth-boring bits typically employ at least one rolling cone cutter, rotatably mounted thereon. The bit is secured to the lower end of a drillstring that is rotated from the surface or by downhole motors. The cutters mounted on the bit roll and slide upon the bottom of the borehole as the drillstring is rotated, thereby engaging and disintegrating the formation material. The rolling cutters are provided with teeth that are forced to penetrate and gouge the bottom of the borehole by weight from the drillstring.

As the cutters roll and slide along the bottom of the borehole, the cutters, and the shafts on which they are rotatably mounted, are subjected to large static loads from the weight on the bit, and large transient or shock loads encountered as the cutters roll and slide along the uneven surface of the bottom of the borehole. Thus, most earth-boring bits are provided with precision-formed journal bearings and bearing surfaces, as well as sealed lubrication systems to increase drilling life of bits. The lubrication systems typically are sealed to avoid lubricant loss and to prevent contamination of the bearings by foreign matter such as abrasive particles encountered in the borehole. A pressure compensator system minimizes pressure differential across the seal so that the lubricant pressure is equal to or slightly greater than the hydrostatic pressure in the annular space between the bit and the sidewall of the borehole.

The bearing is designed so that a lubricant film exists between the load bearing surfaces. The lubricant film between bearing surfaces may be so thin that the irregular surface features of the relatively moving surfaces interact.

The current method of bearing design is, for the most part, by trial and error in the field, by slightly modifying current designs after reviewing their field performance, or by designing and building physical models for testing in a laboratory. Earth boring bits are subject to extreme pressures and temperatures and the ability of the bit, and in particular the seals and bearing surfaces, to operate longer than prior-art results in an earth-boring bit having a higher load capacity and an increased life and therefore more economical operation. Designing by trial and error is expensive and time consuming.

To date, of the mixed-lubrication computer models that have been developed to assist in bearing design, most are based on an ideally supported shaft and have not taken into consideration the shaft deflection, misalignment, and asperity contact with heat transfer in the bearings. These computer models have been used for the bearing systems of hard disk drives where small journal and thrust bearings undertake small loads and for crankshaft bearings in automotive engine where journal bearings undertake heavy loads.

### SUMMARY OF THE INVENTION

Embodiments of the present invention beneficially provide a method and program product for optimizing the design of an earth boring bit through the use of a steady-state mixed thermo-elastic-hydrodynamic computer model that considers the effects of surface roughness, asperity contact, surface thermoelastic deformations, the temperature-pressure-dependant characteristics of lubricant viscosity and the system's geometric constraints, such as the shaft support and the misalignment between the bearing surfaces. The computer model allows for the design of a bit that performs under severe operating conditions. In the preferred embodiment the computer model is applied to journal bearings and in an alternate embodiment, the computer model is applied to coupled journal-thrust bearings.

In one embodiment of the present invention, the method of the design process first involves populating the computer model with design parameters for the particular drill bit. The design parameters may include such things as the general layout of the drill bit, the material selected for the manufacture of the bit and the associated material properties, and the properties of the lubricant to be used in the drill bit bearings. The design process then involves a series of calculations by which the hydrodynamic and asperity contact pressure within the bearings of the drill bit is calculated and the system is balanced. Iterations of the design process may be required to achieve the desired drill bit and bearing design.

Embodiments of the present invention also include a computer readable medium to optimize the design of an earth boring bit. For example, according to an embodiment of the present invention, a computer readable medium includes a set of instructions that, when executed by a computer, causes the computer to accept the input of initial design parameters, performs a series of calculations, and returns an optimal design for an earth boring bit. In an alternative embodiment, the set of instructions, when executed by a computer, will cause the computer to perform a series of calculations that will provide an optimal design for bearings in an earth boring bit.

In another embodiment of the present invention, a system to optimize the design of an earth boring bit can include a computer having a processor, memory coupled to the processor, and an earth boring bit optimization program product stored in the memory. The earth boring bit optimization program product can include instructions to perform the operation of receiving input data, including the input data required to perform the operation of optimizing the design of an earth boring bit, and in one embodiment, the input data required to optimize the bearings of an earth boring bit.

The result of embodiments of the present invention is the design of an earth boring bit that comprises a compact bearing design with high power density. The computer model has been validated with experimentally measured data.

### BRIEF DESCRIPTION OF THE DRAWINGS

So that the manner in which the features and advantages of the invention, as well as others which will become apparent, may be understood in more detail, a more particular description of the invention briefly summarized above may be had by reference to the embodiments thereof which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 is a sectional view of a portion of an earth-boring bit constructed in accordance with this invention.

FIG. 2 diagrammatically shows the geometry of the angular misalignment of a journal-thrust-bearing system.

FIG. 3 shows an embodiment of the overall earth boring bit design optimization process.

FIG. 4 shows an embodiment of the design optimization process of bearing parts of the earth boring drill bit.

FIG. 5 shows an alternative embodiment of the design optimization process of bearing parts of the earth boring drill bit.

FIG. 6 shows another alternative embodiment of the design optimization process of bearing parts of the earth boring drill bit.

### DETAILED DESCRIPTION OF THE EMBODIMENTS

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art.

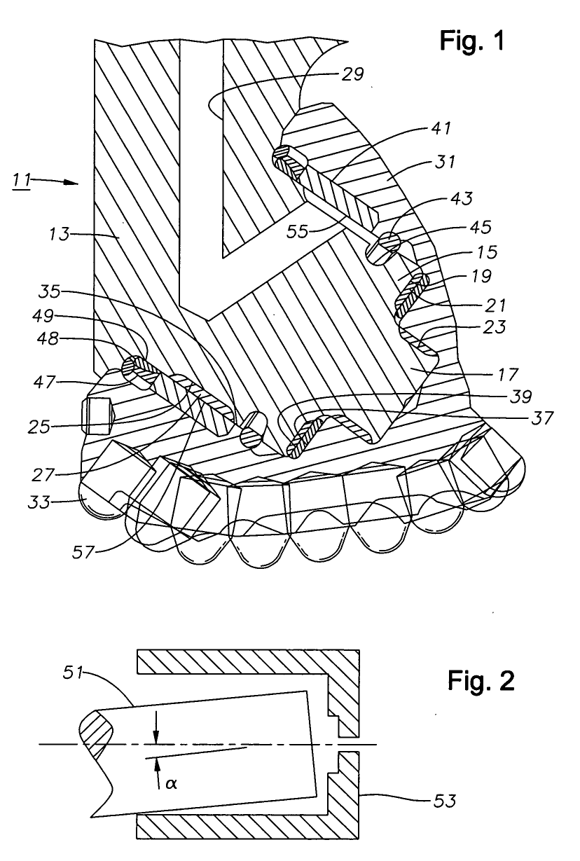

Referring to FIG. 1, bit 11 has at least one bit leg 13 and normally three. Each bit leg 13 has a bearing pin 15 that extends downward and inward toward an axis of rotation of bit 11. Bearing pin 15 has a cylindrical nose 17 on an inner end that is of lesser diameter than remaining portions of bearing pin 15. An inward facing annular thrust shoulder 19 surrounds nose 17. Thrust shoulder 19 is located in a plane perpendicular to an axis of bearing pin 15. In this embodiment, thrust shoulder 19 optionally has an inlay 21 of a hard, wear resistant material. Similarly nose 17 may have an inlay 23 of the same wear resistant material on its cylindrical exterior.

Bearing pin 15 has a partially cylindrical journal bearing surface 25 that extends around its lower side. In this embodiment, an optional inlay 27 of a hard wear resistant material is located in journal bearing surface 25. Since the thrust imposed on bit 11 is downward, inlay 27 does not need to extend to the upper side of bearing pin 15. A lubricant passage 29 extends through bit leg 13 and bearing pin 15 to the upper side of bearing pin 15. A pressure compensator (not shown) supplies pressurized lubricant to passage 29.

A cutter or cone 31 mounts rotatably to bearing pin 15. Cone 31 has a plurality of teeth 33 on its exterior. FIG. 1 shows teeth 33 from all three cones 31 of bit 11 rotated into a single plane. Teeth 33 may be hard metal inserts pressed into mating holes in the body of cone 31, as shown. Alternately, they may be steel teeth milled into the exterior of cone 31.

Cone 31 has a central cavity 35 for rotatably mounting on bearing pin 15. Cavity 35 has a thrust shoulder 37 that is perpendicular to the axis of cone 31 for mating with bearing pin thrust shoulder 19. A thrust washer 39 is located between thrust shoulders 19 and 37. In the preferred embodiment, thrust washer 39 is not fixed to either thrust shoulder 19 or 37, although it could be brazed or welded to one of the shoulders 19 or 37.

A bearing sleeve 41 is located in the cavity of cone 31 in this embodiment to serve as part of a seal assembly 49. A variety of seals could be used. In this example, bearing sleeve 41 rotates with cone 31 and slidingly engages a rigid seal ring 47 in this embodiment. Seal 47 is also formed preferably of a hardened metal and is urged by an elastomeric energizing ring, 48, against bearing sleeve 41. A retainer ring 43 extends around cavity 35 in engagement with a retaining groove 45 to hold cone 31 on bearing pin 15. Another type of retainer uses balls (not shown). Seal assembly 49 seals lubricant within the bearing spaces between bearing pin 15 and cone 31.

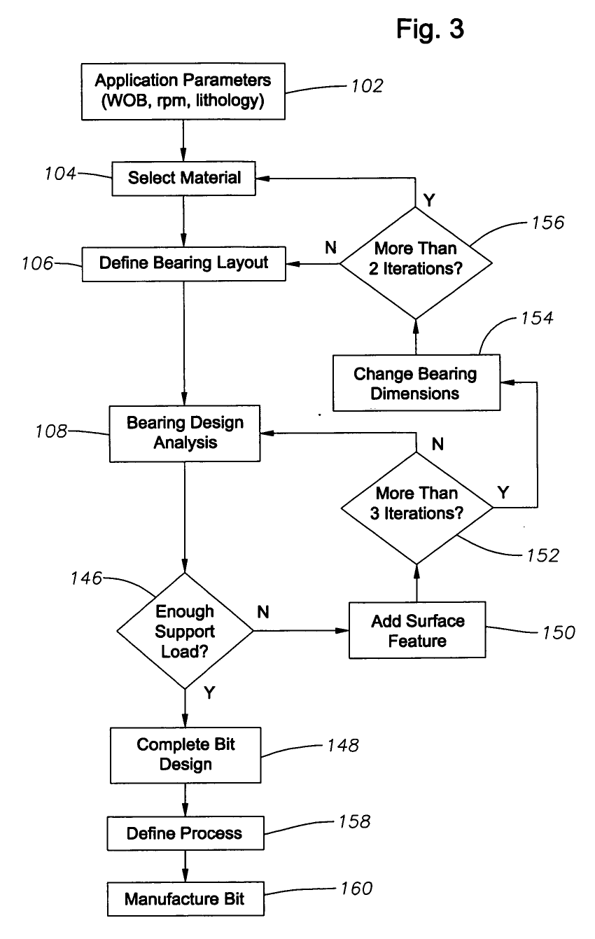

Turning to FIG. 3, an embodiment of the design optimization process of the earth boring drill bit is shown. The design optimization process involves the use of a steady-state mixed thermo-elastic-hydrodynamic computer model that considers the effects of surface roughness, asperity contact, surface thermoelastic deformations, the temperature-pressure-dependant characteristics of lubricant viscosity and the system's geometric constraints, such as the shaft support and the misalignment between the bearing surfaces.

First, the application parameters, such as the weight on bit, the rotational speed of the bit, the compressive strength of the rock formation, and the load to be applied to the bit are input in the computer model as indicated in step 102. In the preferred embodiment, the application parameters may be selected from a library of possible, most commonly used, or preferred application parameters. In an alternate embodiment, the application parameters may be manually input into the computer model.

In the next step of the design process, step 104, the material, and relevant properties for such material, for the drill bit, including for the bearings and journals, is selected. In the preferred embodiment, a library of the material properties of commonly used materials exists and by selecting a material from the library, the material properties associated with such material are input into the computer model. The material properties for materials that do not exist in the library may be input manually into the computer model.

Next, referring to step 106, the basic design parameters defining the layout of the bearings is entered. This might include such information as the diameter of the bit, the length of the bit overall, the type of cutting surface, the diameter of the bearings, the length of the bearings, and the roughness of the bearing surfaces. In the preferred embodiment, a library of customary designs is contained within the computer model for various standard sized bits and when a design is selected from the library for using in the computer model, all required design parameters are input into the computer model. Alternatively, the design parameters defining the layout of the bearing may be entered manually into the computer model. After having completed steps 102 through 106, the bearing design analysis is performed in step 108.

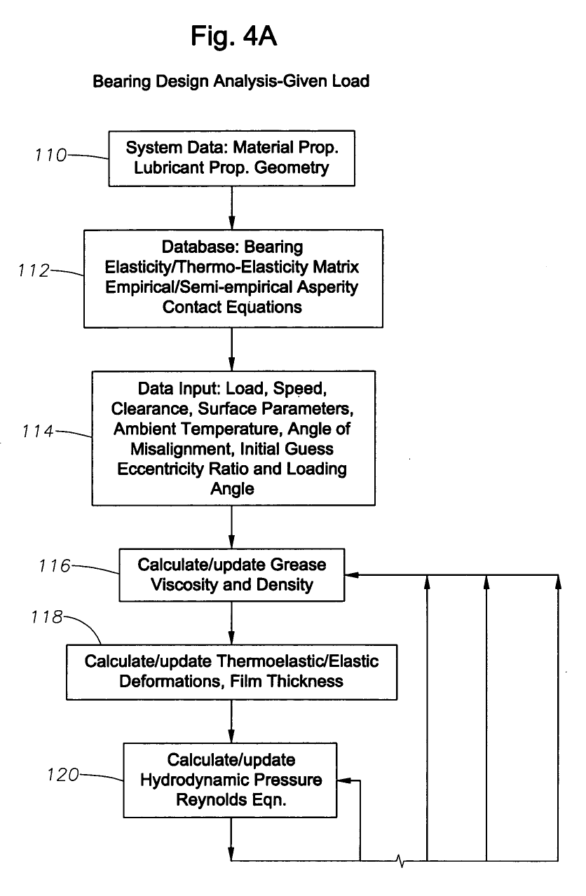

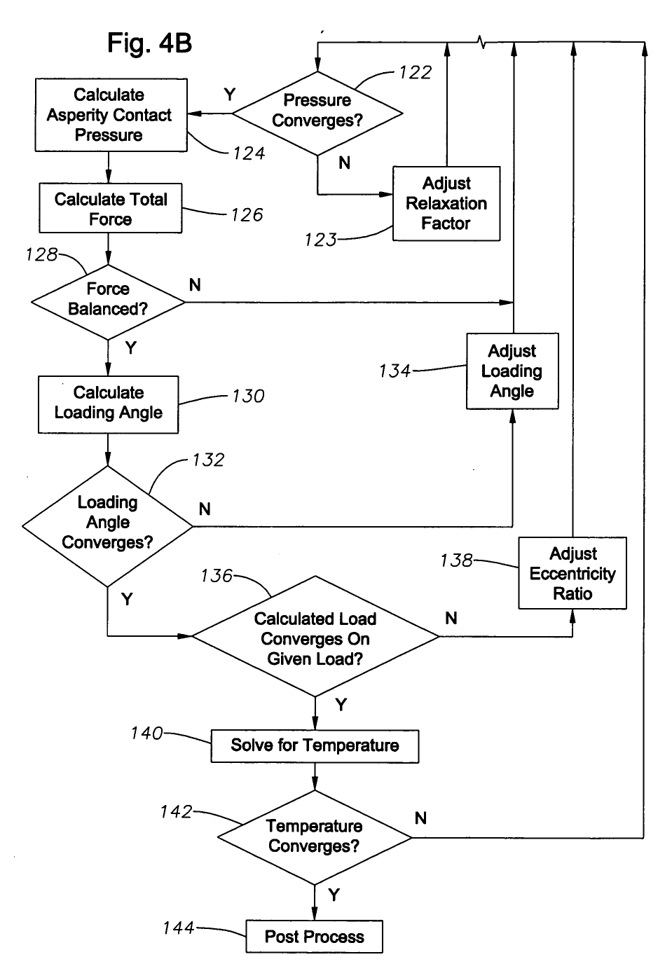

FIG. 4 shows an embodiment of the bearing design analysis of step 108. This step 108 optimizes the bearing parts of the earth boring drill bit. The first step 110 in the bearing design analysis is to input the system data. System data includes mechanical and thermal properties of the bearing parts such as material properties, lubricant properties, and geometry.

Material properties of the bearing parts may include, for example, the modulus of elasticity, the tensile and compressive strength and other physical properties of the material selected to construct the drill bit components. In the preferred embodiment, the material properties input in step 104 will be used in step 110. Alternatively, material properties for the bearing parts in step 110 may be selected from a library of the material properties of commonly used materials and by selecting a material from the library, the material properties associated with such material are input into the computer model. Alternatively, the material properties for the bearing parts may be manually entered into the computer model.

Lubricant properties in step 110 may include, for example, the viscosity parameters, density parameters, thermal conductivity, specific heat and other properties of the lubricant to be used. In the preferred embodiment, a lubricant property may be selected from a library of commonly used lubricants and by selecting the lubricant from the library, the lubricant properties associated with such lubricant are input into the computer model. Alternatively, the lubricant properties may be manually entered into the computer model.

Geometry data in step 110 may include, for example, the diameter of the bit, the length of the bit overall, the type of cutting surface, the diameter of the bearings, the length of the bearings, and the roughness of the bearing surfaces. In the preferred embodiment, the design parameters defining the layout of the bearings from step 106 will be used in step 110. Alternatively, geometry data for the bearing parts in step 110 may be selected from a library of standard configurations and by selecting a configuration from the library, the geometry data associated with configuration are input into the computer model. Alternatively, the geometry data for the bearing parts may be manually entered into the computer model.

Following the input of the system data, a database required for the computer model is populated in step 112. Elasticity and thermoelasticity influence-function matrices of both journal and bearing, and either semi-empirical or empirical relationship of asperity contact pressure and the gap between the two mating surfaces are used by the computer model. The elasticity matrix provides the relationship between the force applied to the bearing and displacement. The thermoelasticity matrix provides the relationship between the elemental temperature rise and the displacement due to thermal expansion. In the preferred embodiment, the matrices are generated from the system data input in step 110 and no further input is required.

The semi-empirical asperity contact equation relates to the physical interaction between the rough bearing surfaces. The semi-empirical asperity contact equation is used to relate the gap between the two mating surfaces and the contact area and the contact pressure. In the preferred embodiment, a library of asperity contact equations for various standard surfaces exists and by selecting the surface for the relevant bearing part, the computer model is populated with the appropriate asperity contact equation. Alternatively, an asperity contact equation for the bearing surfaces may be manually input into the computer model.

Data input is required in the next step 114 of the process. Such data may include the anticipated load on each bearing, the speeds of the rotating part, the bearing clearances, the surface parameters of the bearing surfaces, the ambient temperature profile during operation, and the angle of misalignment between the centerlines of the journal and the bearing. In the preferred embodiment, application parameters from step 102, such as the weight on bit, the rotational speed of the bit, the compressive strength of the rock formation, and the estimated side loads are used to calculate the load acting on each bearing. The current ambient temperature can be calculated from the given temperature profile.

The statistical surface parameters, such as root-mean-square average and autocorrelation length of the bearing surfaces, may be calculated from measured data. Statistical surface parameters may be used to account for the roughness effects of the bearing surface on lubrication. Alternatively, a deterministic approach, such as a finite-element-based computer model with real surface, may be used for the lubrication analysis. The deterministic approach may allow for greater accuracy but will require more computational time.

Turning to FIG. 2, the angle of misalignment α between the centerlines of the journal 51 and the cone bearing 53 is shown schematically and greatly exaggerated. The angle of misalignment is the result of the geometrical misalignment during the manufacturing and assembly process as well as deflection of the journal 51. In one embodiment, the angle of misalignment is not input as a specific number, but rather is calculated by the computer model from the information provided in steps 102, 104, 106, 110, and 112. More particularly, the estimated loads on the bit from step 102, the layout of the bearings and geometry data provided in steps 106 and 110 may be used to calculate the angular misalignment between the centerlines of the journal and the bearing.

Returning to FIG. 4, in step 114 an initial estimate of the eccentricity ratio and loading angle is input. The eccentricity is the divergence between the bearing centerline and the steady-state journal centerline. The eccentricity ratio is the ratio between eccentricity and the bearing clearance and may be estimated using the geometry data from step 110.

The next step is the calculation of the lubricant viscosity and density in step 116. Both the density and viscosity of the lubricant may be a function of temperature and pressure. The parameters required to determine the viscosity and density at a given temperature and pressure were input in the computer model in step 110. The viscosity of the lubricant will directly impact the load capacity of both the journal and thrust bearings. In one embodiment, the viscosity is calculated by the empirical viscosity-temperature-pressure relationship suggested by Bair. (S. Bair, “The High Pressure Rheology of a Soap-thickened Grease,” Tribology Transactions, 37 (1994) 646-650.) incorporated by reference in its entirety:

$$μ = {μ}_{g} exp ( \frac{- 2.3 {C}_{1} ( T - {T}_{g} ) F}{{C}_{2} + ( T - {T}_{g} ) F} )$$

where the subscript g stands for the glass transition point of the lubricant, T is temperature, C₁ and C₂ are base oil coefficients and F is a base oil parameter.

In one embodiment, the lubricant is assumed to have uniform viscosity equal to the average viscosity of the lubricant film. In an alternate embodiment, viscosity variation across the thickness of the lubricant film is considered.

The thermoelastic deformation and film thickness are calculated in the next step 118. The deformation of the bearing and journal surfaces may be expressed as the summation of the elastic and thermal deformations. Because the bearing temperature is relatively uniform, the thermal deformation of the journal may be expressed by the following thermal-expansion equation:

ε_{BT}(θ, ΔT)=α_{T}ΔTr(1+ε cos(θ−φ))

where ΔT is the average temperature increase in the bearing, the product of α_{T}ΔTr is the clearance change and 1+εcos(θ−φ) is the adjustment at a different circumferential location when c, the eccentricity ratio, is given. δ_{BT} is the thermal deformation of the bearing, α_{T} is a thermal expansion coefficient, r is bearing radius, θ is a circumferential co-ordinate and φ is the bearing or loading angle.

The journal thermal deformation, the journal elastic deformation, and the bearing elastic deformation may be calculated using the influence-function methods described by Shi and Wang (F. H. Shi, Q. Wang, “A mixed-TEHD Model for Journal-Bearing Conformal Contacts—Part I: Model Formulation and Approximation of Heat Transfer Considering Asperity Contact,” Journal of Tribology, 120 (1998) 198-205) and Wang et al (Q. Wang, F. H. Shi, S. C. Lee, “A mixed-TEHD Model for Journal-Bearing Conformal Contacts—Part II: Contact, Film Thickness and Performance Analyses,” Journal of Tribology, 120 (1998) 206-213), both incorporated by reference in their entireties. The total deformation of the bearing is the sum of the result of the above thermal deformation equation and the result of the elastic deformation found through the influence-function method. The total deformation of the journal is the sum of the thermal and elastic deformation, both calculated using the influence-function method.

The total film thickness is the average gap between two rough surfaces. The average gap will be the sum of the nominal clearance, including angular misalignment between the journal and the bearing, and the surface deformation. The total film thickness, h_{T} may be calculated as follows:

$${h}_{T} = c + e cos ( θ - ϕ ) + α ( z - \frac{l}{2} ) cos ( θ - ϕ ) + {δ}_{J} + {δ}_{B}$$

where c is the bearing clearance, e is the eccentricity ratio, φ is the bearing or loading angle, α is the misalignment angle, z is a width coordinate, l is the bearing length, and δ_{J} and δ_{B} is the thermoelastic deformation of the journal and bearing surfaces, respectively.

Next, in step 120 the hydrodynamic pressure is calculated by solving an average Reynolds equation that describes the relationship between the hydrodynamic pressure and the lubricant film thickness:

$$\frac{\partial }{{R}_{B} \partial θ} ( {φ}_{θ} \frac{ρ {h}^{3}}{η} \frac{\partial p}{{R}_{B} \partial θ} ) + \frac{\partial }{\partial z} ( {φ}_{z} \frac{ρ {h}^{3}}{η} \frac{\partial p}{\partial z} ) = ( 6 U \frac{\partial ρ {h}_{T}}{{R}_{B} \partial θ} ) + 6 U σ \frac{\partial {ρφ}_{S}}{{R}_{B} \partial θ}$$

where φ_{θ} and φ_{z} are pressure-flow factors and φ_{S} is a shear-flow factor. Subscript B refers to the bearing, R is a radius, ρ is density, h is compliance, p is pressure, θ is a circumferential coordinate, z is a width coordinate, h_{T} is total film thickness, U is the journal speed, and σ is the root-mean-square of the roughness. In one embodiment, Reynolds boundary conditions may be used in solving this average Reynolds equation.

Thus far in the process, no iterations or alternative sequences have been presented. At this point in the process, alternative paths are presented. Following the calculation of hydrodynamic pressure, the computer model determines in step 122 if the pressure converges. This is accomplished by comparing the calculated pressures from successive iterations. The pressure is considered to have converged when the values from successive iterations are within a given tolerance. The tolerance may be, for example, within 10⁻⁵ to 10⁻⁶. If the pressure converges, the computer model continues to step 124. In one embodiment, if the initial pressure and hydrodynamic pressure are not within a selected tolerance in step 122, the computer model goes to step 123 where a relaxation factor is introduced or adjusted, then the computer model returns to step 120 where the hydrodynamic pressure is recalculated. The relaxation factor is a value used to assist in the convergence of an iterative process that is either diverging or slow to converge. Alternatively, other inputs may be modified. Steps 120 through 123 may be repeated as many times as necessary to achieve a pressure convergence within the selected tolerance.

If the pressure converges in step 122, the computer model continues to step 124 and calculates asperity contact pressure. Asperity interaction is one of the major features in mixed lubrication, in which the contacting asperities share a portion of the normal load applied to the bearing. The semi-empirical asperity contact equation approximates the relationship between the asperity contact pressure and the average gap between the two mating surfaces. The average gap is required to compute the asperity contact load. One such rough surface contact model that may be utilized for this purpose was developed by Lee and Ren (S. C. Lee, N. Ren, “Behavior of Elastic-Plastic Rough Surface Contacts as Affected by the Surface Topography, Load and Materials,” Tribology Transactions, 39 (1996) 67-74), which is incorporated by reference in their entireties.

If it is determined however, that there is no physical contact between the bearing surfaces, step 124 is not required. The ratio of the film thickness over root-mean-square roughness may be used to determine when step 124 is required. In the preferred embodiment, if film thickness over root-mean-square roughness is less than 3, physical contact between bearing surfaces may be assumed and step 124 should be performed. Other equations or factors may be used to determine if step 124 is required.

In the next step 126, the total force is calculated. The total force is the sum of the forces due to hydrodynamic pressure and the asperity contact pressure. The next step 128 in the procedure is to ask if the force is balanced. In order to determine if the force is balanced, the hydrodynamic and asperity contact pressure is integrated over the surface of the bearings and compared to previous iterations of the same calculation. If the force is not balanced in step 128, the computer model goes to step 116, an adjustment is made to the calculated viscosity and density in step 116, and steps 116 though 128 are repeated as many times are required until the force converges in step 128.

Once the force converges in step 128, the computer model moves to step 130 where the loading angle is calculated. The loading angle is the angle between the vertical and horizontal components of the total force. The loading angle may be calculated by establishing the vector components of the total force. In the next step 132, the procedure determines if the loading angle converges. This is accomplished by comparing the loading angle estimate of step 114 with the loading angle calculated in step 130. If the loading angle is not within a given tolerance, the procedure continues to step 134 where the loading angle is adjusted. The procedure then returns to step 116 and steps 116 through 132 are repeated until the loading angle is within a given tolerance.

If the loading angle is within the tolerance, the procedure continues to step 136 where the procedure determines if the load converges to the given load. This is accomplished by comparing the force calculated in step 126 with the load provided as input data in step 114. If the force difference is not within a given tolerance, the procedure continues to step 138 where the eccentricity ratio is adjusted. The procedure then returns to step 116 and steps 116 through 136 are repeated until the load is within a given tolerance.

If the load is within the given tolerance, the process continues by solving for temperature in step 140. An energy equation is used to calculate the heat generated with the bearing. Heat may be generated by the interaction of the lubricant with solid surfaces, the lubricant with itself, and through contact friction.

Next, the computer model determines if the temperature converges in step 142. This is decided by balancing the heat generation as determined in step 140 with a calculated heat transfer. If the heat being generated and transferred does not balance, in the preferred embodiment, the procedure returns to step 116. The loading angle or eccentricity or other inputs may be modified before repeating steps 116 through 142 until the temperature converges. This completes the first iteration of the bearing design analysis part of the procedure.

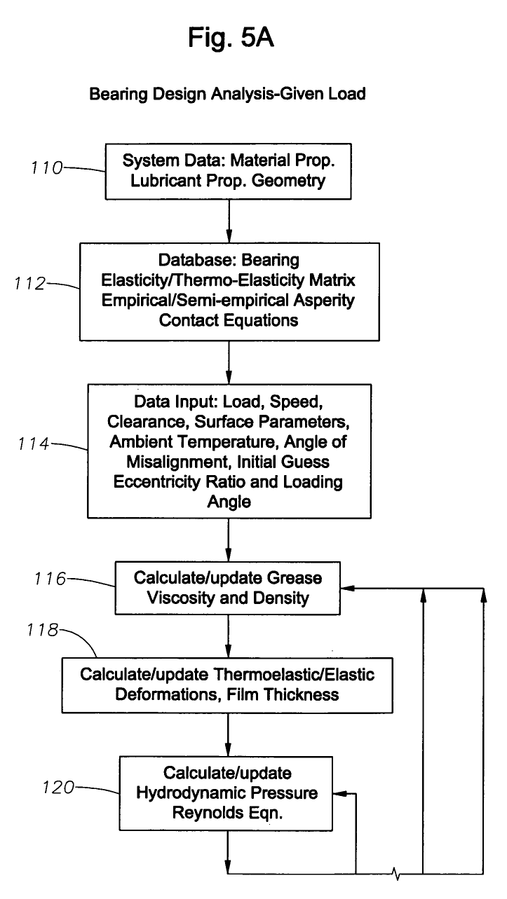

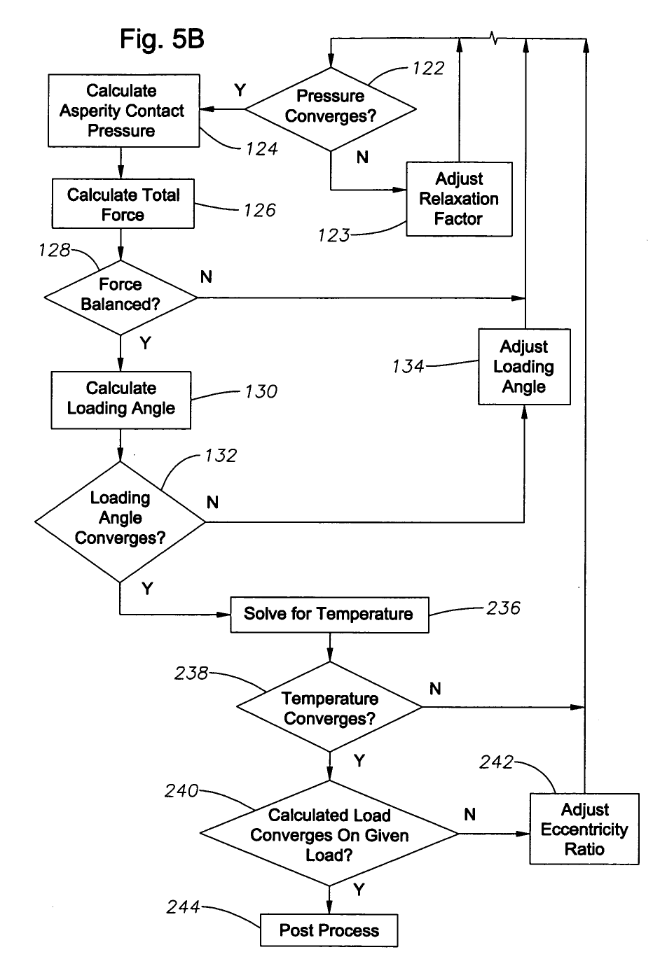

An alternative procedure to the bearing design analysis is shown on FIG. 5. Steps 110 through 134 are the same as in the first embodiment. However, after the loading angle converges in step 132, the procedure next solves for temperature in step 236. An energy equation as known and understood by those skilled in the art is used to calculate the heat generated with the bearing. Heat may be generated by the interaction of the lubricant with solid surfaces, the lubricant with itself, and through contact friction. Next, the computer model determines if the temperature converges in step 238. This is accomplished by comparing the temperatures calculated in successive iterations. If the temperature difference is within a preset tolerance, in the preferred embodiment, the procedure returns to step 116. The loading angle or eccentricity or other inputs may be modified before repeating steps 116 through 132 and 236 through 238 until the temperature converges.

If the heat being generated and being transferred balances, the computer model continues to step 240, where the procedure determines if the load converges. This is accomplished by comparing the force calculated in step 126 with the load provided as input data in step 114. If the force difference is not within a given tolerance, the procedure continues to step 242 where the eccentricity ratio is adjusted. The procedure then returns to step 116 and steps 116 through 132 and 236 through 240 are repeated until the force difference is within a given tolerance. If the load converges, this completes the first iteration in the bearing design analysis procedure.

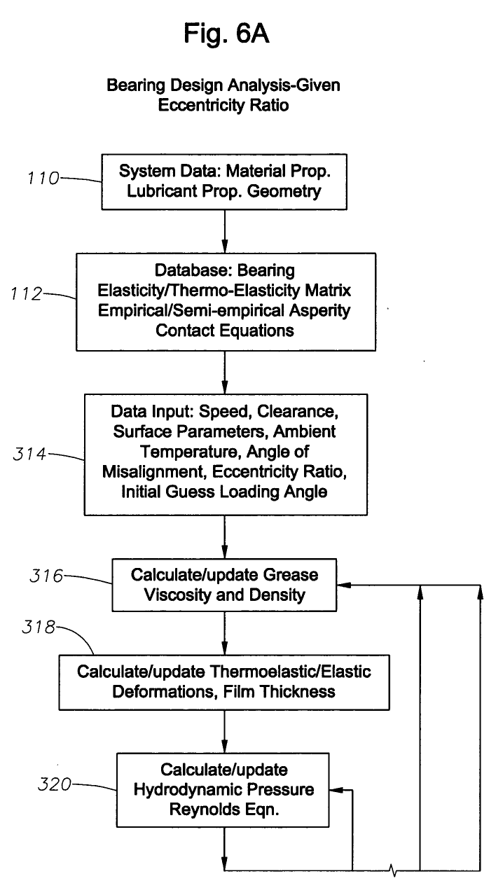

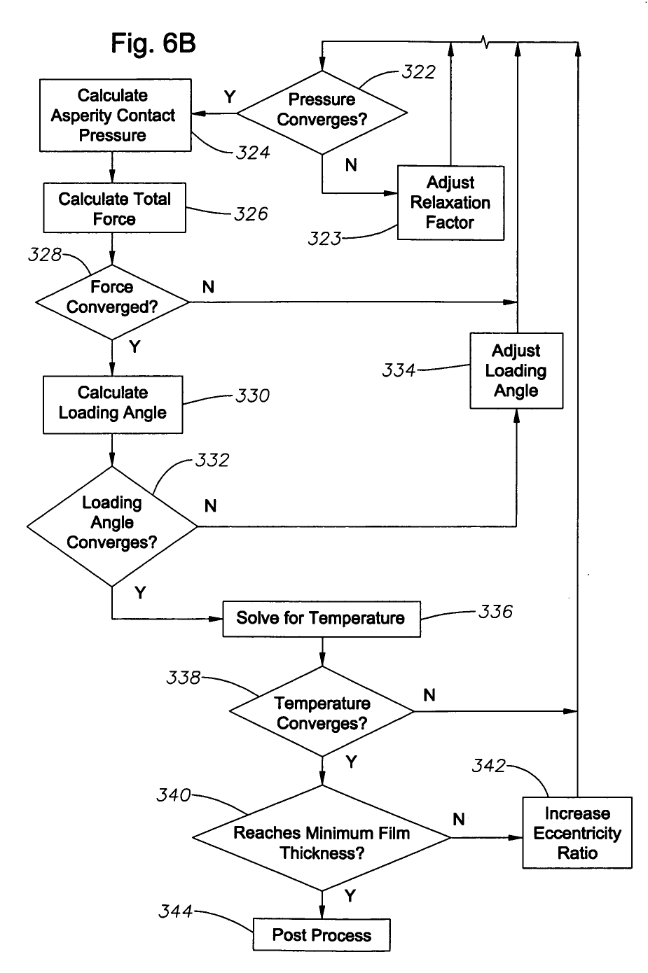

Another alternative procedure to the bearing design analysis is shown in FIG. 6. Steps 110 and 112 are the same as in the first two embodiments. However, rather than including a load as data input in step 314, an eccentricity ratio is instead provided. Data input is required in step 314 of the process. Such data may include, the speed of the rotating part, the bearing clearances, the surface parameters of the bearing surfaces, the ambient temperature profile during operation, the angle of misalignment between the journal and the bearing, and the eccentricity ratio. The application parameters from step 102, such as the weight on bit, the rotational speed of the bit, the compressive strength of the rock formation, and the estimated load that applied to the bit and bearings as a whole, may be used to calculate the load, speed, and clearance of each bearing part. The current ambient temperature can be calculated from the given temperature profile.

The surface parameters of the bearing surfaces may be calculated either deterministically or statistically. Statistical parameters may be used by the computer model to treat the influence of the roughness of the surface of the bearings on lubrication. Alternatively, a deterministic approach, such as a finite-element-based model with local enrichment, may be used by the computer model for the lubrication analysis. The deterministic approach may allow for greater accuracy, but will require more computational time.

Turning to FIG. 2, the angular misalignment α of the journal 51 and the cone bearing 53 is shown schematically and greatly exaggerated. The angle of misalignment α is the result of the geometrical misalignment during the manufacturing and assembly process as well as deflection of the journal 51. In the preferred embodiment, the angle of misalignment is not input as a specific number, but rather is calculated by the computer model from the information provided in steps 102, 104, 106, 110, and 112. More particularly, the estimated load on the bit from step 102, the layout of the bearings and geometry data provided in steps 106 and 110, the material properties of steps 104 and 110, and the deformation relationships from step 112 may be used to calculate the angular misalignment between the journal and the bearing. Returning to FIG. 6, an initial guess of the eccentricity ratio and loading angle is input.

The next step is the calculation of the lubricant viscosity and density in step 316. Both the density and viscosity of the lubricant may be a function of temperature and pressure. The parameters required to determine the viscosity and density at a given temperature and pressure were input in the computer model in step 110. The viscosity of the lubricant will directly impact the load capacity of both the journal and thrust bearings. In one embodiment, the viscosity is calculated by the empirical viscosity-temperature-pressure relationship suggested by Bair. (S. Bair, “The High Pressure Rheology of a Soap-thickened Grease,” Tribology Transactions, 37 (1994) 646-650.):

$$μ = {μ}_{g} exp ( \frac{- 2.3 {C}_{1} ( T - {T}_{g} ) F}{{C}_{2} + ( T - {T}_{g} ) F} )$$

where the subscript g stands for the glass transition point of the lubricant, T is temperature, C₁ and C₂ are base oil coefficients and F is a base oil parameter.

In one embodiment, the lubricant is assumed to have uniform viscosity equal to the average viscosity of the lubricant film. In an alternate embodiment, viscosity variation across the thickness of the lubricant film is considered.

The thermoelastic deformation and film thickness are calculated in the next step 318. The deformation of the bearing and journal surfaces may be expressed as the summation of the elastic and thermal deformations. Because the bearing temperature is relatively uniform, the thermal deformation of the bearing may be expressed by the following thermal-expansion equation:

δ_{BT}(θ, ΔT)=α_{T}ΔTr(1+ε cos(θ−φ))

where ΔT is the average temperature increase in the bearing, the product of α_{T}ΔTr is the clearance change and 1+ε cos(θ−φ) is the adjustment at a different circumferential location when ε, the eccentricity ratio, is given. δ_{BT} is the thermal deformation of the bearing, α_{T} is a thermal expansion coefficient, r is bearing radius, θ is a circumferential co-ordinate and φ is the bearing or loading angle.

The journal thermal deformation, the journal elastic deformation, and the bearing elastic deformation may be calculated using the influence-function methods described by Shi and Wang (F. H. Shi, Q. Wang, “A mixed-TEHD Model for Journal-Bearing Conformal Contacts—Part I: Model Formulation and Approximation of Heat Transfer Considering Asperity Contact,” Journal of Tribology, 120 (1998) 198-205) and Wang et al (Q. Wang, F. H. Shi, S. C. Lee, “A mixed-TEHD Model for Journal-Bearing Conformal Contacts—Part II: Contact, Film Thickness and Performance Analyses,” Journal of Tribology, 120 (1998) 206-213). The total deformation of the bearing is the sum of the result of the above thermal deformation equation and the result of the elastic deformation found through the influence-function method. The total deformation of the journal is the sum of the thermal and elastic deformation, both calculated using the influence-function method.

The total film thickness is the average gap between two rough surfaces. The average gap will be the sum of the nominal clearance, including angular misalignment between the journal and the bearing, and the surface thermoelastic deformation. The total film thickness, h_{T} may be calculated as follows:

$${h}_{T} = c + e cos ( θ - ϕ ) + α ( z - \frac{l}{2} ) cos ( θ - ϕ ) + {δ}_{J} + {δ}_{B}$$

where c is the average clearance, e is the eccentricity, φ is the bearing or loading angle, α is the misalignment angle, z is a width coordinate, l is the bearing length, and δ_{J} and δ_{B} is the thermoelastic deformation of the journal and bearing surfaces respectively.

Next, in step 320 the hydrodynamic pressure is calculated by solving an average Reynolds equation that describes the relationship between the hydrodynamic pressure and the lubricant film thickness:

$$\frac{\partial }{{R}_{B} \partial θ} ( {φ}_{θ} \frac{ρ {h}^{3}}{η} \frac{\partial p}{{R}_{B} \partial θ} ) + \frac{\partial }{\partial z} ( {φ}_{z} \frac{ρ {h}^{3}}{η} \frac{\partial p}{\partial z} ) = ( 6 U \frac{\partial ρ {h}_{T}}{{R}_{B} \partial θ} ) + 6 U σ \frac{\partial {ρφ}_{S}}{{R}_{B} \partial θ}$$

where φ_{θ} and φ_{z} are pressure-flow factors and φ_{S} is a shear-flow factor. Subscript B refers to the bearing, R is a radius, ρ is density, h is compliance, p is pressure, θ is a circumferential coordinate, z is a width coordinate, h_{T} is total film thickness, U is the bearing speed, and σ is the root-mean-square of the roughness. In one embodiment, Reynolds boundary conditions may be used in solving this average Reynolds equation.

Thus far in the process, no iterations or alternative sequences have been presented. At this point in the process, alternative paths are presented. Following the calculation of hydrodynamic pressure, the computer model determines in step 322 if the pressure is converged. This is accomplished by comparing calculated pressures from successive iterations. The pressure is considered to have converged when the value from successive iterations are within a given tolerance. The tolerance may be, for example, within 10⁻⁵ to 10⁻⁶. If the pressure converges, the computer model continues to step 324. In one embodiment, if the differences of the calculated hydrodynamic pressures in successive iterations are not within a predefined tolerance in step 322, the computer model goes to step 323 where a relaxation factor is adjusted and the computer model returns to step 320 where the hydrodynamic pressure is recalculated. The relaxation factor is a value used to assist in the convergence of an iterative process that is either diverging or slow to converge and is predefined in the computer code. Alternatively, other inputs may be modified. Steps 320 through 323 may be repeated as many times as necessary to achieve a pressure convergence within the selected tolerance.

If the pressure converges in step 322, the computer model continues to step 324 and calculates asperity contact pressure. Asperity interaction is one of the major features in mixed lubrication, in which the contacting asperities share a portion of the normal load applied to the bearing. The semi-empirical asperity contact equation approximates the relationship between the asperity contact pressure and the average gap between the two mating surfaces. The average gap is required to compute the asperity contact load. One such rough surface contact computer model that may be utilized for this purpose was developed by Lee and Ren (S. C. Lee, N. Ren, “Behavior of Elastic-Plastic Rough Surface Contacts as Affected by the Surface Topography, Load and Materials,” Tribology Transactions, 39 (1996) 67-74.)

If it is determined, however, that there is no physical contact between the bearing surfaces, step 324 is not required. The ratio of the film thickness over root-mean-square roughness may be used to determine when step 324 is required. In the preferred embodiment, if film thickness over root-mean-square roughness is less than 3, physical contact between bearing surfaces may be assumed and step 324 should be performed. Other equations or factors may be used to determine if step 324 is required.

In the next step 326, the total force is calculated. The total force is the sum of the integration of the hydrodynamic pressure and the asperity contact pressure over the surface of the bearings.

The next step 328 in the procedure is to ask if the force converges. In order to determine if the force converges, the hydrodynamic and asperity contact pressure is integrated over the surface of the bearings and compared to that calculated in the previous iteration. If the force does not converge in step 328, the computer model goes to step 316, an adjustment is made to the grease viscosity and density is modified, and steps 316 through 328 are repeated as many times as required until the force converges in step 328.

Once the force converges in step 328, the computer model moves to step 330 where the loading angle is calculated. The loading angle is the angle between the vertical and horizontal components of the total force. The loading angle may be calculated by establishing the vector components of the total force. If the loading angle does not converge, the procedure continues to step 334 where the loading angle is adjusted. The procedure then returns to step 316 and steps 316 through 332 are repeated until the difference of loading angles between successive iterations is within a given tolerance.

If the loading angle is within the tolerance, the procedure continues to step 336 where the temperature is calculated. An energy equation is used to calculate the heat generated with the bearing. Heat may be generated by the interaction of the lubricant with solid surfaces, the lubricant with itself, and through contact friction. In the next step 338, the process determines if the temperature converges. This is accomplished by comparing the temperatures calculated in successive iterations. If the temperature difference is within a preset tolerance, in the preferred embodiment, the procedure returns to step 316. The loading angle or eccentricity ratio or other inputs may be modified before repeating steps 316 through 338 until the temperature converges. This completes the first iteration of the bearing design analysis part of the procedure.

Returning to FIG. 3, the next step 146 in the overall drill bit design process is to determine if there is sufficient load support. Result from step 108 is used to determine, in step 146, if there is enough load support for the weight and load applied. If it is determined that the load can be supported within design parameters, then the computer model moves to step 148.

If there is not enough load support, then the computer model would move to step 150 and a surface feature, such as a textured surface, may be applied to one or more bearing surfaces. Applying a textured surface creates an addition step that is required in the manufacturing process so it would be preferable to not require any textured surfaces. However if there is not enough load support in step 146, applying a textured surface can provide additional lifting forces. The surface to which the surface texture will be applied may be an alloy steel such as one containing 0.15% C, 0.8% Mn, 0.55% Cr, 0.85% Ni or 0.25% Mo or other similar material.

Textures surfaces will enhance lubrication by retaining some of the lubrication during rotation of cutter 31 (FIG. 1). Having textured surfaces may provide lower coefficients of sliding friction between the sliding surfaces over earth boring bit prior-art using smooth surfaces. Additionally having a textured surface may lower the operating temperature, thereby reducing thermal fatigue crack nucleation. A textured surface, according to recent research work, has the benefit of reducing the damage accrued under start and stop conditions. It serves as both lubricant reservoir to help lubricating the surface and damper to absorb shock loads. A surface texture could take the form of parallel grooves, arrays of dimples of different shapes, sizes and depths, and micro-asperities of different shapes, sizes and heights.

Returning to FIG. 1, bearing sleeve 41 has a bearing face 55 which corresponds to a bearing face 57 of inlay 27. A textured surface may be applied to at least one of the bearing faces 55 or 57 and may also be applied to inlays 21 and 23, thrust shoulder 37 and thrust washer 39.

In one embodiment, after having added the texture, as indicated by step 152, if there have been only a few of iterations of step 150, for example, three or less, the computer model returns to step 108 and repeats steps 110 through 146. Alternatively, if there has been a larger number of iteration of step 150, for example more than three, and the computer model still finds that there is not sufficient load support, the computer model moves to step 154 and the bearing dimensions are changed. In one embodiment, as indicated by step 156, if there have been more than two iterations of step 154, the computer model returns to step 104 and repeats steps 104 through 146. If there have been, for example, two or less iterations of step 154, the computer model returns to step 106 and repeats steps 106 through 146. In alternate embodiments, various numbers of iterations may take the computer model to alternative steps or may alter other dimensions for the next iteration.

After it has been determined that there is sufficient load support in step 146, a process for manufacturing the bit is defined by step 158 and the bit is manufactured per step 160.

It is important to note that while embodiments of the present invention have been thus far described in the context of a fully functional method, those skilled in the art will appreciate that the mechanism of the present invention and/or aspects thereof are capable of being distributed in the form of a computer readable medium of instructions in a variety of forms for execution on a processor, processors, or the like, and that the present invention applies equally regardless of the particular type of signal bearing media used to actually carry out the distribution. Examples of computer readable media include: nonvolatile, hard-coded type media such as read only memories (ROMs) or erasable, electrically programmable read only memories (EEPROMs), recordable type media such as floppy disks, hard disk drives and CD-ROMs, and transmission type media such as digital and analog communication links.

Embodiments of the present invention would include a computer readable medium to optimize the design of an earth boring bit. For example, according to an embodiment of the present invention, a computer readable medium includes a set of instructions that, when executed by a computer, cause the computer to accept the input of initial design parameters, perform a series of calculations that will return an optimal design for an earth boring bit. In an alternative embodiment, the set of instructions, when executed by a computer, will cause the computer to perform a series of calculations that will provide an optimal design for bearings in an earth boring bit.

More specifically, returning to FIG. 3, the computer readable medium includes a set of instructions, that when executed by a computer will perform a series of calculations that solve a steady-state mixed thermo-elasto-hydrodynamic computer model that considers the effects of surface roughness, asperity contact, surface thermoelastic deformations, the temperature-pressure-dependant characteristics of lubricant viscosity and the system's geometric constraints, such as the shaft support and the misalignment between the bearing surfaces.

First, the set of instructions will cause the computer to accept the input of application parameters, such as the weight on bit, the rotational speed of the bit, the compressive strength of the rock formation, and the load to be applied to the bit in step 102. In the preferred embodiment, the computer readable medium will contain a library of application parameters most commonly used, or preferred application parameters and the set of instructions will allow a particular application parameter to be selected from this library. In an alternate embodiment, the set of instructions will allow the computer to accept application parameters that are manually input into the computer.

In the next step 104, the set of instructions will cause the computer to accept the input of a material, and relevant properties for such material, for the drill bit, including materials for the bearings and journals. In the preferred embodiment, the computer readable medium will contain a library of the material properties of commonly used materials and the set of instructions will allow a material to be selected from the library. In this embodiment, the set of instructions will cause the material properties associated with the selected material to be accepted by the computer. In an alternate embodiment, the set of instructions will allow the computer to accept material and material properties that are manually input into the computer.

Next, referring to step 106, the set of instructions will cause the computer to accept the input of the basic design parameters defining the layout of the bearings is entered. This might include such information as the diameter of the bit, the length of the bit overall, the type of cutting surface, the diameter of the bearings, the length of the bearings, and the roughness of the bearing surfaces. In the preferred embodiment, the computer readable medium will contain a library of customary designs for various standard sized bits as well as all required bearing design parameters associated with those bit designs and the set of instructions will allow a design to be selected from the library. In this embodiment, the set of instructions will cause the bearing design parameters associated with the selected bit to be accepted by the computer. In an alternate embodiment, the set of instructions will allow the computer to accept the bearing design parameters defining the layout of the bearing that are manually input into the computer. After having completed steps 102 through 106, the bearing design analysis is performed in step 108.

FIG. 4 shows an embodiment of the bearing design analysis of step 108. In this step 108, the set of instructions will cause the computer to receive data and perform calculations that optimizes the bearing parts of the earth boring drill bit. In the first step 110, the set of instructions causes the computer to accept the input of system data. System data includes mechanical and thermal properties of the bearing parts such as material properties, lubricant properties, and geometry.

Material properties of the bearing parts may include, for example, the modulus of elasticity, thermal conductivity, and thermal expansion coefficient and other physical properties of the material selected to construct the drill bit components. In the preferred embodiment, the material properties input in step 104 will be used in step 110. Alternatively, the computer readable medium will contain a library of the material properties of commonly used materials for use in step 110 and the set of instructions will allow a material to be selected from the library. In this embodiment, the set of instructions will cause the material properties associated with the selected material to be accepted by the computer. In an alternate embodiment, the set of instructions will allow the computer to accept material and material properties that are manually input into the computer.

Lubricant properties in step 110 may include, for example, the viscosity parameters, density parameters, thermal conductivity, specific heat and other properties of the lubricant to be used. In the preferred embodiment, the computer readable medium will contain a library of commonly used lubricants and associated lubricant properties and the set of. instructions will allow a lubricant to be selected from the library. In this embodiment, the set of instructions will cause the lubricant properties associated with the selected lubricant to be accepted by the computer. In an alternate embodiment, the set of instructions will allow the computer to accept lubricant properties that are manually input into the computer.

Geometry data in step 110 may include, for example, the diameter of the bit, the length of the bit overall, the type of cutting surface, the diameter of the bearings, the length of the bearings, and the roughness of the bearing surfaces. In the preferred embodiment, the set of instructions will cause the computer to accept the design parameters defining the layout of the bearings from step 106 to be used in step 110. Alternatively, the computer readable medium will contain a library of standard configurations and associated geometry data and the set of instructions will allow a configuration to be selected from the library. In this embodiment, the set of instructions will cause the geometry data associated with the selected configuration to be accepted by the computer. In an alternate embodiment, the set of instructions will allow the computer to accept data for the bearing parts that are manually input into the computer.

Following the input of the system data, the set of instructions will cause the computer to populate a database required for future calculations in step 112. Elasticity and thermoelasticity influence-function matrices of both journal and bearing, and either semi-empirical or empirical relationship of asperity contact pressure and the gap between the two mating surfaces are required for future calculations. The elasticity matrix provides the relationship between the force applied to the bearing and displacement. The thermoelasticity matrix provides the relationship between the elemental temperature rise and the displacement due to thermal expansion. In the preferred embodiment, the set of instructions causes the elasticity and thermoelasticity matrices to be generated from the system data input in step 110 and no further input is required.

The semi-empirical asperity contact equation relates to the physical interaction between the rough bearing surfaces. The semi-empirical asperity contact equation is used to relate the gap between the two mating surfaces and the contact area and the contact pressure. In the preferred embodiment, the computer readable medium will contain a library of standard surfaces and asperity contact equations associated with those standard surfaces and the set of instructions will allow a standard surface to be selected from the library. In this embodiment, the set of instructions will cause the appropriate asperity contact equation associated with the selected standard surface to be accepted by the computer. In an alternate embodiment, the set of instructions will allow the computer to accept an asperity contact equation for the bearing surfaces that is manually input into the computer.

The set of instructions will next cause the computer to accept data input that is required in the next step 114 of the process. Such data may include the anticipated load on each bearing, the speeds of the rotating part, the bearing clearances, the surface parameters of the bearing surfaces, the ambient temperature profile during operation, and the angle of misalignment between the centerlines of the journal and the bearing. In the preferred embodiment, the set of instructions allows the computer to accept the application parameters from step 102, such as the weight on bit, the rotational speed of the bit, the compressive strength of the rock formation, and the estimated side loads are used to calculate the load acting on each bearing. The set of instructions will cause the computer to calculate the current ambient temperature from the temperature profile that was input.

The set of instructions will cause the computer to calculate the statistical surface parameters, such as root-mean-square average and autocorrelation length, of the bearing surfaces from measured data. In addition, the set of instructions may cause the computer to apply statistical surface parameters to account for the roughness effects of the bearing surface on lubrication or alternatively, to utilize a deterministic approach, such as a finite-element-based computer model with real surface, for the lubrication analysis. The deterministic approach may allow for greater accuracy but will require more computational time.

Turning to FIG. 2, the angle of misalignment a between the centerlines of the journal 51 and the cone bearing 53 is shown schematically and greatly exaggerated. The angle of misalignment is the result of the geometrical misalignment during the manufacturing and assembly process as well as deflection of the journal 51. In one embodiment, the set of instructions causes the computer to calculate the angle of misalignment from the information input in steps 102, 104, 106, 110, and 112. More particularly, the set of instructions causes the computer to use the estimated loads on the bit from step 102, the layout of the bearings and geometry data provided in steps 106 and 110 to calculate the angular misalignment between the centerlines of the journal and the bearing.

Returning to FIG. 4, in step 114 the set of instructions causes the computer to accept an initial guess of the eccentricity ratio and loading angle. The eccentricity is the divergence between the bearing centerline and the steady-state journal centerline. The eccentricity ratio is the ratio between eccentricity and the bearing clearance and the set of instructions may cause the computer to estimate the eccentricity ratio using the geometry data from step 110.

In the next step 116 the set of instructions causes the computer to calculate the lubricant viscosity and density. Both the density and viscosity of the lubricant may be a function of temperature and pressure. The parameters required to determine the viscosity and density at a given temperature and pressure were input into the computer in step 110. The viscosity of the lubricant will directly impact the load capacity of both the journal and thrust bearings. In one embodiment, the set of instructions causes the computer to calculate the viscosity by evaluating the empirical viscosity-temperature-pressure relationship suggested by Bair. (S. Bair, “The High Pressure Rheology of a Soap-thickened Grease,” Tribology Transactions 37 (1994) 646-650.):

$$μ = {μ}_{g} exp ( \frac{- 2.3 {C}_{1} ( T - {T}_{g} ) F}{{C}_{2} + ( T - {T}_{g} ) F} )$$

where the subscript g stands for the glass transition point of the lubricant, T is temperature, C₁ and C₂ are base oil coefficients and F is a base oil parameter.

In one embodiment, the set of instructions causes the computer to assume that the lubricant has uniform viscosity equal to the average viscosity of the lubricant film. In an alternate embodiment, the set of instructions causes the computer to assume that there is a variation in viscosity across the thickness of the lubricant film.

The set of instructions causes the computer to calculate the thermoelastic deformation and film thickness in the next step 118. The deformation of the bearing and journal surfaces may be expressed as the summation of the elastic and thermal deformations. Because the bearing temperature is relatively uniform, the thermal deformation of the bearing may be expressed by the following thermal-expansion equation:

δ_{BT}(θ, ΔT)=α_{T}ΔTr(1+ε cos(θ−φ))

where ΔT is the average temperature increase in the bearing, the product of α_{T}ΔTr is the clearance change and 1+ε cos(θ−φ) is the adjustment at a different circumferential location when ε, the eccentricity ratio, is given. δ_{BT} is the thermal deformation of the bearing, α_{T} is a thermal expansion coefficient, r is bearing radius, θ is a circumferential co-ordinate and φ is the bearing or loading angle.

The set of instructions may cause the computer to calculate the journal thermal deformation, the journal elastic deformation, and the bearing elastic deformation using the influence-function methods described by Shi and Wang (F. H. Shi, Q. Wang, “A mixed-TEHD Model for Journal-Bearing Conformal Contacts—Part I: Model Formulation and Approximation of Heat Transfer Considering Asperity Contact,” Journal of Tribology 120 (1998) 198-205) and Wang et al (Q. Wang, F. H. Shi, S. C. Lee, “A mixed-TEHD Model for Journal-Bearing Conformal Contacts—Part II: Contact, Film Thickness and Performance Analyses,” Journal of Tribology 120 (1998) 206-213). The set of instructions may cause the computer to calculate the total deformation of the bearing as the sum of the result of the above thermal deformation equation and the result of the elastic deformation found through the influence-function method. The set of instructions may cause the computer to calculate the total deformation of the journal as the sum of the thermal and elastic deformation, with both the thermal and elastic deformation calculated using the influence-function method.

The total film thickness is the average gap between two rough surfaces. The set of instructions may cause the computer to calculate the average gap as the sum of the nominal clearance, including angular misalignment between the journal and the bearing, and the surface thermoelastic deformation. The set of instructions may cause the computer to calculate the total film thickness, h_{T} as follows:

$${h}_{T} = c + e cos ( θ - ϕ ) + α ( z - \frac{l}{2} ) cos ( θ - ϕ ) + {δ}_{J} + {δ}_{B}$$

where c is the average clearance, e is the eccentricity, φ is the bearing or loading angle, α is the misalignment angle, z is a width coordinate, l is the bearing length, and δ_{J} and δ_{B} is the thermoelastic deformation of the journal and bearing surfaces, respectively.

Next, in step 120 the set of instructions may cause the computer to calculate the hydrodynamic pressure by solving an average Reynolds equation that describes the relationship between the hydrodynamic pressure and the lubricant film thickness:

$$\frac{\partial }{{R}_{B} \partial θ} ( {φ}_{θ} \frac{ρ {h}^{3}}{η} \frac{\partial p}{{R}_{B} \partial θ} ) + \frac{\partial }{\partial z} ( {φ}_{z} \frac{ρ {h}^{3}}{η} \frac{\partial p}{\partial z} ) = ( 6 U \frac{\partial ρ {h}_{T}}{{R}_{B} \partial θ} ) + 6 U σ \frac{\partial {ρφ}_{S}}{{R}_{B} \partial θ}$$

where φ_{θ} and φ_{z} are pressure-flow factors and φ_{S} is a shear-flow factor. Subscript B refers to the bearing, R is a radius, ρ is density, h is compliance, ρ is pressure, θ is a circumferential co-ordinate, z is a width coordinate, h_{T} is total film thickness, U is the bearing speed, and σ is the root-mean-square of the roughness. In one embodiment, the set of instructions may cause the computer to solve this average Reynolds equation by using Reynolds boundary conditions.

Thus far in the process, the set of instructions has not provided for any iterations or alternative sequences. At this point in the process, alternative paths are presented by the set of instructions. Following the calculation of hydrodynamic pressure, it is determined in step 122 if the pressure converges by comparing the calculated pressures from successive iterations. The pressure is considered to have converged when the values from successive iterations are within a given tolerance as indicated in the set of instructions. The set of instructions may set the tolerance, for example, within 10⁻⁵ to 10⁻⁶. If the pressure converges, the computer model continues to step 124. In one embodiment, if the initial pressure and hydrodynamic pressure are not within a selected tolerance in step 122, the set of instructions goes to step 123 where the set of instructions introduces or adjusts a relaxation factor then the set of instructions returns to step 120 where set of instructions causes the computer to recalculate the hydrodynamic pressure. The relaxation factor is a value used to assist in the convergence of an iterative process that is either diverging or slow to converge. Alternatively, the set of instructions may cause inputs to be modified. The set of instructions may require Steps 120 through 123 be repeated as many times as necessary to achieve a pressure convergence within the selected tolerance.

If the pressure converges in step 122, the set of instructions continues to step 124 and causes the computer to calculate asperity contact pressure. Asperity interaction is one of the major features in mixed lubrication, in which the contacting asperities share a portion of the normal load applied to the bearing. The semi-empirical asperity contact equation approximates the relationship between the asperity contact pressure and the average gap between the two mating surfaces. The average gap is required to compute the asperity contact load. One such rough surface contact model that may be utilized by the set of instructions for this purpose was developed by Lee and Ren (S. C. Lee, N. Ren, “Behavior of Elastic-Plastic Rough Surface Contacts as Affected by the Surface Topography, Load and Materials,” Tribology Transactions, 39 (1996) 67-74.)

If it is determined by the computer however, that there is no physical contact between the bearing surfaces, step 124 is not required. The set of instructions may require the computer to use the ratio of the film thickness over root-mean-square roughness to determine when step 124 is required. In the preferred embodiment, if film thickness over root-mean-square roughness is determined by the computer to be less than 3, physical contact between bearing surfaces may be assumed by the computer and step 124 should be performed. Other equations or factors may be used by the set of instructions and computer to determine if step 124 is required.

In the next step 126, the set of instructions causes the computer to calculate total force. The total force is the sum of the integration of the hydrodynamic pressure and the asperity contact pressure over the surface of the bearings. In the next step 128, the set of instructions causes the computer to determine if the force is balanced. In order to determine if the force is balanced, the set of instructions causes the computer to integrate the hydrodynamic and asperity contact pressure over the surface of the bearings and compare the result to previous iterations of the same calculation. If the computer determines that the force is not balanced in step 128, the set of instructions goes to step 116, an adjustment is made to the calculated viscosity in step 116, and steps 116 though 128 are repeated as many times as required until the computer determines that the force converges in step 128.

Once the computer determines that the force converges in step 128, the set of instructions moves to step 130 where the set of instructions causes the computer to calculate the loading angle. The loading angle is the angle between the vertical and horizontal components of the total force. The loading angle may be calculated by establishing the vector components of the total force. In the next step 132, the set of instructions causes the computer to determine if the loading angle converges. This is accomplished by causing the computer to compare the loading angle estimate of step 114 with the loading angle calculated in step 130. If the loading angle does not converge to within a given tolerance, the set of instructions continues to step 134 where the set of instructions causes the computer to adjust the loading angle. The set of instructions then returns to step 116 and steps 116 through 132 are repeated until the loading angle converges to within a given tolerance.

If the loading angle converges, the procedure continues to step 136 where the set of instructions causes the computer to determine if the load converges. This is accomplished by the computer comparing the force calculated in step 126 with the load provided as input data in step 114. If the computer determines that the difference in loads is not within a given tolerance, the set of instructions continues to step 138 where the set of instructions causes the computer to adjust the eccentricity ratio. The set of instructions then returns to step 116 and steps 116 through 136 are repeated until the computer determines that the difference in loads is within a given tolerance.

If the computer determines that difference in loads is within the given tolerance, the set of instructions continues by causing the computer to solve for temperature in step 140. The set of instructions causes the computer to use an energy equation to calculate the heat generated within the bearing. Heat may be generated by the interaction of the lubricant with solid surfaces, the lubricant with itself, and through contact friction.

Next, the set of instructions causes the computer to determine if the temperature converges in step 142. This is determined by balancing the heat generation as determined in step 140 with a calculated heat transfer. If the computer determines that the heat being generated and transferred does not balance, in the preferred embodiment, the set of instructions returns to step 116. The loading angle or eccentricity or other inputs may be modified by the computer before repeating steps 116 through 142 until the temperature converges. This completes the first iteration of the bearing design analysis.

An alternative set of instructions for the bearing design analysis is shown in FIG. 5. Steps 110 through 134 are the same as in the first embodiment. However, after the computer determines that the loading angle converges in step 132, the computer next solves for temperature in step 236. The set of instructions causes the computer to use an energy equation to calculate the heat generated with the bearing. Heat may be generated by the interaction of the lubricant with solid surfaces, the lubricant with itself, and through contact friction. Next, the set of instructions causes the computer to determine if the temperature converges in step 238. This is accomplished by the computer by comparing the temperatures calculated in successive iterations. If the computer determines that the temperature difference is within a preset tolerance, in the preferred embodiment, the set of instructions returns to step 116. The set of instructions may cause the computer to modify the loading angle or eccentricity or other inputs before repeating steps 116 through 132 and 236 through 238 until the temperature converges.

If the computer determines that the heat being generated and being transferred balances, the set of instructions continues to step 240, where the computer determines if the load converges, by comparing the force calculated in step 126 with the load provided as input data in step 114. If the computer determines that the difference in loads is not within a given tolerance, the set of instructions continues to step 242 where the eccentricity ratio is adjusted. The set of instructions then returns to step 116 and steps 116 through 132 and 236 through 240 are repeated until the computer determines that the difference in loads is within a given tolerance. If the load converges, this completes the first iteration in the bearing design analysis procedure.

Another alternative procedure to the bearing design analysis is shown in FIG. 6. Steps 110 and 112 are the same as in the first two embodiments. However, rather than requiring that a load be input in step 314 the set of instructions requires that an eccentricity ratio is instead provided. The set of instructions will next cause the computer to accept data input required in the next step 314 of the process. Such data may include the anticipated load on each bearing, the speeds of the rotating part, the bearing clearances, the surface parameters of the bearing surfaces, the ambient temperature profile during operation, and the angle of misalignment between the centerlines of the journal and the bearing. In the preferred embodiment, the set of instructions allows the computer to accept the application parameters from step 102, such as the weight on bit, the rotational speed of the bit, the compressive strength of the rock formation, and the estimated side loads are used to calculate the load acting on each bearing. The set of instructions will cause the computer to calculate the current ambient temperature from the temperature profile that was input.

The set of instructions may cause the computer to calculate the surface parameters of the bearing surfaces either deterministically or statistically. Statistical parameters may be required by the set of instructions to treat the influence of the roughness of the surface of the bearings on lubrication. Alternatively, a deterministic approach, such as a finite-element-based model with local enrichment, may be required by the set of instructions for the lubrication analysis. The deterministic approach may allow for greater accuracy but will require more computational time.

Turning to FIG. 2, the angular misalignment α of the journal 51 and the cone bearing 53 is shown schematically and greatly exaggerated. The angle of misalignment α is the result of the geometrical misalignment during the manufacturing and assembly process as well as deflection of the journal 51. In the preferred embodiment, the angle of misalignment is not input as a specific number but rather is calculated by the computer model from the information provided in steps 102, 104, 106, 110, and 112. More particularly, the estimated load on the bit from step 102, the layout of the bearings and geometry data provided in steps 106 and 110, the material properties of steps 104 and 110, and the deformation relationships from step 112 may be used to calculate the angular misalignment between the journal and the bearing. Returning to FIG. 6, the set of instructions cause the computer to accept the input of an initial guess of the eccentricity ratio and loading angle.

In the next step, the set of instructions causes the computer to calculate the lubricant viscosity and density in step 316. Both the density and viscosity of the lubricant may be a function of temperature and pressure. The parameters required to determine the viscosity and density at a given temperature and pressure were input in the computer in step 310. The viscosity of the lubricant will directly impact the load capacity of both the journal and thrust bearings. In one embodiment, the viscosity is calculated by the computer empirical viscosity-temperature-pressure relationship suggested by Bair. (S. Bair, “The High Pressure Rheology of a Soap-thickened Grease,” Tribology Transactions, 37 (1994) 646-650.):

$$μ = {μ}_{g} exp ( \frac{- 2.3 {C}_{1} ( T - {T}_{g} ) F}{{C}_{2} + ( T - {T}_{g} ) F} )$$

where the subscript g stands for the glass transition point of the lubricant, T is temperature, C₁ and C₂ are base oil coefficients and F is a base oil parameter.

In one embodiment, the set of instructions causes the computer to assume that the lubricant has uniform viscosity equal to the average viscosity of the lubricant film. In an alternate embodiment, the set of instructions causes the computer to assume that viscosity varies across the thickness of the lubricant film.

The set of instructions causes the computer to calculate the thermoelastic deformation and film thickness in the next step 318. The deformation of the bearing and journal surfaces may be calculated by the computer as the summation of the elastic and thermal deformations. Because the bearing temperature is relatively uniform, the thermal deformation of the bearing may be calculated by the computer by the following thermal-expansion equation:

δ_{BT}(θ, ΔT)=α_{T}ΔTr(1+ε cos(θ−φ))

where ΔT is the average temperature increase in the bearing, the product of α_{T}ΔTr is the clearance change and 1+εcos(θ−φ) is the adjustment at a different circumferential location when ε, the eccentricity ratio, is given. δ_{BT} is the thermal deformation of the bearing, α_{T} is a thermal expansion coefficient, r is bearing radius, θ is a circumferential co-ordinate and φ is the bearing or loading angle.

The set of instructions may cause the computer to calculate the journal thermal deformation, the journal elastic deformation, and the bearing elastic deformation using the influence-function methods described by Shi and Wang (F. H. Shi, Q. Wang, “A mixed-TEHD Model for Journal-Bearing Conformal Contacts—Part I: Model Formulation and Approximation of Heat Transfer Considering Asperity Contact,” Journal of Tribology, 120 (1998) 198-205) and Wang et al (Q. Wang, F. H. Shi, S. C. Lee, “A mixed-TEHD Model for Journal-Bearing Conformal Contacts—Part II: Contact, Film Thickness and Performance Analyses,” Journal of Tribology, 120 (1998) 206-213). The total deformation of the bearing is calculated by the computer as the sum of the result of the above thermal deformation equation and the result of the elastic deformation found through the influence-function method. The total deformation of the journal is calculated by the computer as the sum of the thermal and elastic deformations, both calculated using the influence-function method.

The total film thickness is the average gap between two rough surfaces. The set of instructions will cause the computer to calculate the average gap as the sum of the nominal clearance, including angular misalignment between the journal and the bearing, and the surface thermoelastic deformation. The set of instructions will cause the computer to calculate the total film thickness, h_{T} as follows:

$${h}_{T} = c + e cos ( θ - ϕ ) + α ( z - \frac{l}{2} ) cos ( θ - ϕ ) + {δ}_{J} + {δ}_{B}$$

where c is the average clearance, e is the eccentricity, φ is the bearing or loading angle, α is the misalignment angle, z is a width coordinate, l is the bearing length, and δ_{J} and δ_{B} is the thermoelastic deformation of the journal and bearing surfaces, respectively.

Next, in step 320 the set of instructions will cause the computers to calculate hydrodynamic pressure by solving an average Reynolds equation that describes the relationship between the hydrodynamic pressure and the lubricant film thickness:

$$\frac{\partial }{{R}_{B} \partial θ} ( {φ}_{θ} \frac{ρ {h}^{3}}{η} \frac{\partial p}{{R}_{B} \partial θ} ) + \frac{\partial }{\partial z} ( {φ}_{z} \frac{ρ {h}^{3}}{η} \frac{\partial p}{\partial z} ) = ( 6 U \frac{\partial ρ {h}_{T}}{{R}_{B} \partial θ} ) + 6 U σ \frac{\partial {ρφ}_{S}}{{R}_{B} \partial θ}$$

where φ_{θ} and φ_{z} are pressure-flow factors and φ_{S} is a shear-flow factor. Subscript B refers to the bearing, R is a radius, ρ is density, h is compliance, p is pressure, θ is a circumferential co-ordinate, z is a width coordinate, h_{T} is total film thickness, U is the bearing speed, and σ is the root-mean-square of the roughness. In one embodiment, Reynolds boundary conditions may be used by the computer in solving this average Reynolds equation.

Thus far in the process, no iterations or alternative sequences have been presented. At this point in the process, alternative paths are presented by the set of instructions. Following the calculation of hydrodynamic pressure, the set of instructions causes the computer to determine in step 322 if the pressure has converged. This is accomplished by the computer by comparing calculated pressures from successive iterations. The pressure is considered to have converged when the value from successive iterations are within a given tolerance. The tolerance indicated by the set of instructions may be, for example, within 10⁻⁵ to 10⁻⁶. If the computer determines that the pressure converges, the set of instructions continues to step 324. In one embodiment, if the difference of the hydrodynamic pressures calculated by the computer in successive iterations is not within a predefined tolerance in step 322, the set of instructions goes to step 323 where the set of instructions causes the computer to adjust or introduce a relaxation factor and the set of instructions returns to step 320 where the hydrodynamic pressure is recalculated. The relaxation factor is a value used to assist in the convergence of an iterative process that is either diverging or slow to converge and is predefined in the computer code. Alternatively, other inputs may be modified by the computer. Steps 320 through 323 may be repeated as many times as necessary to achieve a pressure convergence within the selected tolerance.

If the pressure converges in step 322, the set of instructions continues to step 324 and the computer calculates asperity contact pressure. Asperity interaction is one of the major features in mixed lubrication, in which the contacting asperities share a portion of the normal load applied to the bearing. The semi-empirical asperity contact equation approximates the relationship between the asperity contact pressure and the average gap between the two mating surfaces. The average gap is required to compute the asperity contact load. One such rough surface contact model that may be utilized by the set of instructions for this purpose was developed by Lee and Ren (S. C. Lee, N. Ren, “Behavior of Elastic-Plastic Rough Surface Contacts as Affected by the Surface Topography, Load and Materials,” Tribology Transactions, 39 (1996) 67-74.)

If it is determined by the computer however, that there is no physical contact between the bearing surfaces, step 324 is not required. The ratio of the film thickness over root-mean-square roughness may be used by the set of instructions and computer to determine when step 324 is required. In the preferred embodiment, if the computer determines that the film thickness over root-mean-square roughness is less than 3, physical contact between bearing surfaces may be assumed and step 324 should be performed by the computer. Other equations or factors may be used by the set of instructions to determine if step 324 is required.

In the next step 326, the set of instructions causes the computer to calculate the total force. The total force is the sum of the integration of the hydrodynamic pressure and the asperity contact pressure over the surface of the bearings.

In the next step 328 the set of instructions causes the computer to ask if the force converges. In order to determine if the force converges, the hydrodynamic and asperity contact pressure is integrated by the computer over the surface of the bearings and the result is compared to the previous iteration. If the computer determines that force does not converge in step 328, the set of instructions goes to step 316, an adjustment is made by the computer to the grease viscosity and density, and steps 316 though 328 are repeated as many times as required until the force converges in step 328.

Once the force converges in step 328, the set of instructions moves to step 330 where the set of instructions causes the computer to calculate the loading angle. The loading angle is the angle between the vertical and horizontal components of the total force. The loading angle may be calculated by the computer by establishing the vector components of the total force. If the loading angle does not converge, the set of instructions continues to step 334 where the loading angle is adjusted by the computer. The set of instructions then returns to step 316 and steps 316 through 332 are repeated by the computer until the loading angle converges to within a given tolerance.)

If the loading angle converges to within the tolerance, the set of instructions continues to step 336 where the set of instructions causes the computer to calculate the temperature. An energy equation is used by the computer to calculate the heat generated within the bearing. Heat may be generated by the interaction of the lubricant with solid surfaces, the lubricant with itself, and through contact friction. In the next step 338, the set of instructions causes the computer to determine if the temperature converges. This is accomplished by the computer by comparing the temperatures calculated in successive iterations. If the temperature difference is within a preset tolerance, in the preferred embodiment, the set of instructions returns to step 316. The loading angle or eccentricity ratio or other inputs may be modified by the computer before repeating steps 316 through 338 until the temperature converges. This completes the first iteration of the bearing design analysis part of the procedure.

Returning to FIG. 3, in the next step 146 the set of instructions causes the computer to determine if there is sufficient load support. The result from step 108 is used by the computer to determine, in step 146, if there is enough load support for the weight and load applied. If it is determined by the computer that the load can be supported within design parameters, then the set of instructions moves to step 148.

If there is not enough load support, then the set of instructions moves to step 150 and the set of instructions will cause the computer to apply a surface feature, such as a textured surface, may be applied to one or more bearing surfaces. The textured surface can provide additional lifting forces. The surface to which the surface texture will be applied may be an alloy steel such as one containing 0.15% C, 0.8% Mn, 0.55% Cr, 0.85% Ni or 0.25% Mo or other similar material.

Textured surfaces will enhance lubrication by retaining some of the lubrication during rotation of cutter 31 (FIG. 1). Having textured surfaces may provide lower coefficients of sliding friction between the sliding surfaces over earth boring bit prior-art using smooth surfaces. Additionally, having a textured surface may lower the operating temperature, thereby reducing thermal fatigue crack nucleation. A textured surface, according to recent research work, has the benefit of reducing the damage accrued under start and stop conditions. It serves as both lubricant reservoir to help lubricating the surface and damper to absorb shock loads. A surface texture could take the form of parallel grooves, arrays of dimples of different shapes, sizes and depths, and micro-asperities of different shapes, sizes and heights.

Returning to FIG. 1, bearing sleeve 41 has a bearing face 55 which corresponds to a bearing face 57 of inlay 27. A textured surface may be applied by the computer to at least one of the bearing faces 55 or 57 and may also be applied by the computer to inlays 21 and 23, thrust shoulder 37 and thrust washer 39.

In one embodiment, after the computer adds the texture, as indicated by step 152, if there have been, for example, three or less iterations of step 150, the set of instructions returns to step 108 and repeats steps 110 through 146. If there have been more than three iterations of step 150, the set of instructions moves to step 154 and the bearing dimensions are changed by the computer. In one embodiment, as indicated by step 156, if there have been more than two iterations of step 154, the set of instructions returns to step 104 and repeats steps 104 through 146. If there have been, for example, two or less iterations of step 154, the set of instructions returns to step 106 and repeats steps 106 through 146. In alternate embodiments, various numbers of iterations may take the set of instructions to alternative steps or the computer may alter other dimensions for the next iteration.

After it has been determined by the computer that there is sufficient load support in step 146 the set of instructions causes the computer to display the results of the design optimization and suggest a process for manufacturing the bit in step 158. In one embodiment, the set of instructions causes the results to be delivered to a computer aided manufacturing system and the bit is manufactured per step 160.

In the drawings and specification, there have been disclosed a typical preferred embodiment of the invention, and although specific terms are employed, the terms are used in descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as defined in the appended claims.

I claim:

1. A method of designing an earth boring bit, comprising the steps of:
(a) inputting into a computer initial design parameters for a plurality of earth boring bits;
(b) selecting a template design for bearings within the bit;
(c) adjusting the design parameters; and
(d) repeating steps (b) and (c) until the earth boring bit can optimally support a preselected design load.

2. The method of claim 1, wherein step (b) comprises the steps of:
(i) inputting system data into a computer;
(ii) calculating hydrodynamic and asperity contact pressures within the bearings;
(iii) determining if forces and moments within the bearings are balanced;
(iv) adjusting the system data if the forces or moments within the bearings are not balanced; and
(v) repeating steps (ii) through (iv) until heat being generated by the bearings balances heat being transferred in and out of the bearing system.

3. The method of claim 2, wherein step (iii) further comprises the step of determining if a loading angle converges.

4. The method of claim 3, wherein step (iv) comprises adjusting the loading angle.

5. The method of claim 2, wherein step (iv) comprises adjusting an eccentricity ratio of the bearings.

6. The method of claim 2, wherein step (iv) comprises modifying a lubricant film thickness within the bearings.

7. The method of claim 1, wherein step (c) further comprises the step of adding a surface texture to surfaces of the bearings.

8. The method of claim 7, further comprising step of using a numerical model to evaluate and determine the design of the surface texture added to surfaces of the bearings.

9. A method of designing bearings for an earth boring bit, comprising the steps of:
(a) inputting into a computer bearing system data for a plurality of bearings;
(b) calculating hydrodynamic and asperity contact pressures within the bearings;
(c) determining if forces and loading angle within the bearings converge;
(d) adjusting the system data if the forces or loading angle within the bearings do not converge; and
(e) repeating steps (b) through (d) until heat being generated by the bearings balances the heat being transferred in and out of the bearing system.

10. The method of claim 9, wherein step (b) comprises the steps of:
calculating a grease viscosity and grease density;
calculating a thermoelastic and elastic deformation of a bearing and journal;
calculating a lubricant film thickness within the bearings; and
calculating the hydrodynamic pressure distribution across bearing surfaces.
calculating the asperity contact pressure across bearing surfaces.

11. The method of claim 9, wherein step (c) further comprises the step of adjusting the loading angle until the loading angle converges.

12. The method of claim 9, wherein step (c) further comprises the step of adjusting an eccentricity ratio until the force converges.

13. The method of claim 9, wherein step (d) comprises adjusting a lubricant film thickness within the bearings until temperature convergence is achieved.

14. A method of designing bearings for an earth boring bit, comprising the steps of:
(a) inputting into a computer bearing system data for one or more bearings;
(b) calculating hydrodynamic and asperity contact pressures within the bearings;
(c) determining if forces, temperatures, and loading angle within the bearings converge;
(d) adjusting the system data if forces, temperatures, or loading angle within the bearings do not converge; and
(e) repeating steps (b) through (d) until a calculated force balances a selected system data load.

15. The method of claim 14, wherein step (b) comprises the steps of:
calculating a grease viscosity and grease density;
calculating a thermoelastic and elastic deformation of a bearing and journal;
calculating a lubricant film thickness within the bearings; and
calculating the hydrodynamic pressure distribution across bearing surfaces.
calculating the asperity contact pressures across bearing surfaces.

16. The method of claim 14, wherein step (c) further comprises the step of adjusting the loading angle until the loading angle converges.

17. The method of claim 14, wherein step (d) comprises the step of adjusting an eccentricity ratio until the calculated force is substantially equivalent to a given load.

18. A method of designing bearings for an earth boring bit, comprising the steps of:
(a) inputting into a computer bearing system data for a plurality of bearings;
(b) calculating hydrodynamic and asperity contact pressures within the bearings;
(c) determining if forces are balanced and if loading angle and temperatures within the bearings converge;
(d) adjusting the system data if the forces are not balanced or if loading angle and temperatures within the bearings do not converge; and
(e) repeating steps (b) through (d) until a minimum film thickness is achieved.

19. The method of claim 18, wherein step (b) comprises the steps of:
calculating a grease viscosity and grease density;
calculating a thermoelastic and elastic deformation of a bearing and journal;
calculating a lubricant film thickness within the bearings; and
calculating the hydrodynamic pressure distribution across bearing surfaces.
calculating the asperity contact pressure across bearing surfaces.

20. The method of claim 18, wherein step (c) further comprises the step of adjusting the loading angle until the loading angle converges.

21. The method of claim 18, wherein step (d) comprises increasing an eccentricity ratio until the minimum film thickness is achieved.

22. A computer readable medium that is readable by a computer to optimize the design of an earth boring bit, the computer readable medium comprising a set of instructions that, when executed by the computer, cause the computer to perform the following operations:
(a) receiving initial bearing design parameters for bearings within the bit;
(b) receiving a template design for the bearings within the bit;
(c) adjusting the design parameters; and
(d) repeating steps (b) through (c) until the earth boring bit can optimally support a design load.

23. A computer readable medium as defined in claim 22, wherein step (b) further comprises a set of instructions that, when executed by the computer, cause the computer to perform the following operations:
(i) receiving system data as input;
(ii) calculating hydrodynamic and asperity contact pressures within the bearings;
(iii) determining if forces and moments within the bearings are balanced;
(iv) adjusting the system data; and
(v) repeating steps (ii) through (iv) until heat being generated by the bearings balances heat being transferred in and out of the bearing system.

24. A computer readable medium as defined in claim 23, wherein the operation of determining if forces and moments within the bearings are balanced includes determining if a loading angle converges.

25. A computer readable medium as defined in claim 24, wherein the operation of adjusting the system data includes adjusting the loading angle.

26. A computer readable medium as defined in claim 23, wherein the operation of adjusting the system data includes adjusting an eccentricity ratio of the bearings.

27. A computer readable medium as defined in claim 23, wherein the operation of adjusting the system data includes modifying a lubricant film thickness within the bearings.

28. A computer readable medium as defined in claim 22, wherein the operation of adjusting the design parameters includes adding a surface texture to surfaces of the bearing.

29. A computer readable medium as defined in claim 28, wherein the set of instructions further include those to perform the operation of using a numerical model to evaluate and determine the design of the surface texture added to surfaces of the bearings.

30. A computer readable medium that is readable by a computer to optimize the design of bearings of an earth boring bit, the computer readable medium comprising a set of instructions that, when executed by the computer, cause the computer to perform the following operations:
(a) receiving as input bearing system data for one or more bearings;
(b) calculating hydrodynamic and asperity contact pressures within the bearings;
(c) determining if forces and moments within the bearings are balanced;
(d) adjusting the system data if the forces and moments within the bearings are not balanced; and
(e) repeating steps (b) through (d) until heat being generated by the bearings balances heat being transferred in and out of the bearing system.

31. A computer readable medium as defined in claim 30, wherein the operation of calculating hydrodynamic and asperity contact pressures within the bearings includes the following operations:
calculating a grease viscosity and grease density;
calculating a thermoelastic and elastic deformation of a bearing and journal;
calculating a lubricant film thickness within the bearings; and
calculating the hydrodynamic pressure distribution across bearing surfaces.
calculating the asperity contact pressures across bearing surfaces.

32. A computer readable medium as defined in claim 30, wherein the operation of determining if forces and moments within the bearings are balanced includes adjusting the loading angle until the loading angle converges;

33. A computer readable medium as defined in claim 30, wherein the operation of determining if forces and moments within the bearings are balanced includes adjusting an eccentricity ratio until the force converges;

34. A computer readable medium as defined in claim 30, wherein the operation of adjusting the system data includes adjusting a lubricant film thickness within the bearings until temperatures convergence are achieved;

35. A computer readable medium that is readable by a computer to optimize the design of bearings of an earth boring bit, the computer readable medium comprising a set of instructions that, when executed by the computer, cause the computer to perform the following operations:
(a) receiving as input bearing system data for one or more bearings;
(b) calculating hydrodynamic and asperity contact pressures within the bearings;
(c) determining if forces, temperatures, and loading angle within the bearings converge;
(d) adjusting the system data if the forces, temperatures, or loading angle within the bearings do not converge; and
(e) repeating steps (b) through (d) until a calculated force balances a selected system data load.

36. A computer readable medium as defined in claim 35, wherein the operation of calculating hydrodynamic and asperity contact pressures within the bearings includes the following operations:
calculating a grease viscosity and grease density;
calculating a thermoelastic and elastic deformation of a bearing and journal;
calculating a lubricant film thickness within the bearings; and
calculating the hydrodynamic pressure distribution across bearing surfaces.
calculating the asperity contact pressures across bearing surfaces.

37. A computer readable medium as defined in claim 35, wherein the operation of determining if forces, temperatures, and loading angle within the bearings converge includes adjusting the loading angle until the loading angle converges.

38. A computer readable medium as defined in claim 35, wherein the operation of adjusting the system data includes adjusting an eccentricity ratio until the calculated force is substantially equivalent to a given load.

39. A computer readable medium that is readable by a computer to optimize the design of bearings of an earth boring bit, the computer readable medium comprising a set of instructions that, when executed by the computer, cause the computer to perform the following operations:
(a) receiving as input bearing system data for one or more bearings;
(b) calculating hydrodynamic and asperity contact pressures within the bearings;
(c) determining if forces are balanced and if loading angle and temperatures within the bearings converge;
(d) adjusting the system data if the forces are not balanced or if the loading angle or temperatures within the bearings do not converge; and
(e) repeating steps (b) through (d) until a minimum film thickness is achieved.

40. A computer readable medium as defined in claim 39, wherein the operation of calculating hydrodynamic and asperity contact pressures within the bearings includes the following operations:
calculating a grease viscosity and grease density;
calculating a thermoelastic and elastic deformation of a bearing and journal;
calculating a lubricant film thickness within the bearings; and
calculating the hydrodynamic pressure distribution across bearing surfaces.
calculating the asperity contact pressures across bearing surfaces.

41. A computer readable medium as defined in claim 39, wherein operation of determining if forces are balanced and if loading angle and temperatures within the bearings converge includes adjusting the loading angle until the loading angle converges;

42. A computer readable medium as defined in claim 39, wherein operation of adjusting the system data includes increasing an eccentricity ratio until the minimum film thickness is achieved.
